(19) United States
(12) Patent Application Publication
(10) Pub. No.: US 2007/0131721 A1
(43) Pub. Date: Jun. 14, 2007

(54) Dosing system for free flowing and pasty media and a process for its manufacture

(76) Inventors: Isidor Fritschi, Schaffhausen (CH); Kathrin Buchi-Fritschi, Andelfingen/ZH (CH)

Correspondence Address: EDWIN D. SCHINDLER, FIVE HIRSCH AVENUE, P.O. BOX 966, CORAM, NY, 11727-0966, US

(21) Appl. No.: 11/408,267

(22) Filed: Apr. 20, 2006

(30) Foreign Application Priority Data
Apr. 20, 2005 (CH) 00728/05

(51) Int. Cl. B67D 5/42; B65D 47/10

(52) U.S. Cl. 222/391; 222/541.6; 222/541.9

(57) ABSTRACT

A dosing apparatus for small doses of a substance, particularly for types of pharmaceutical substances, includes a shoulder and a nozzle for use as a dropper or sprayer on the shoulder. Two outer arms are connected to the shoulder and a container, preferably formed as a hollow cylinder, is located between the two outer arms. An inner arm is formed at an acute angle to each adjacent outer arm with the two outer arms being connected to one another by way of the two inner arms. Two U-shaped tension arches connect the two inner arms to one another, so that the container is centrally positioned between the two U-shaped tension arches, which the two outer arms being able to be pressed together gradually and repeatedly for providing dosing of the desired substance.

### BACKGROUND OF THE INVENTION

1. Technical Field of the Invention

The present invention relates to a dosing system for a pair of small doses of a substance, particularly for types of pharmaceutical substances, and a process for manufacturing of such a dosing system.

2. Description of the Prior Art

Sprays are used for application of different types of pharmaceutical liquid substances, which generally involve a small bottle or a container with a spray pump, which is either screwed-on or forced-on with a dropper. These spray pumps often include a suction pipe, which projects into the container or the bottle, and a pump mechanism and a spraying nozzle. When the pump is activated, mostly through a pressing-down of a knob or a push button, a dose of the contents of the container is pressed through the nozzle and is atomized as spray. Typical applications of such sprays are as throat/pharynx sprays, nasal spray and ear spray. The pumps for such sprays are built rather elaborately and are costly to manufacture as they consist of several parts, which must be injection molded with tight tolerances to guarantee that the pump is leak-proof and to ensure that spraying and dropping of the smallest of doses takes place reliably over a long period of time. Accordingly, an elaborate arrangement to assemble the components is required.

Sprays are, of course, used for other non-medical purposes too, where sprays with spray pumps or aerosol containers are found, which are filled with a propellant gas; in such cases, only a valve needs to be activated for spraying. A spray is fundamentally suited for such applications, where a dose of a liquid needs to be sprinkled in fine droplets over an area.

In many cases, it is found useful and practical to test only a sample of a substance before the intended application and before one buys the complete spray with the spray pump. For example, in case of a color spray, before one buys the complete aerosol container with the spray pump, one would like to find out whether the tint is as per one's wish or matches with an existing color. This is particularly true when the object to be sprayed cannot be brought to the color shop to ascertain the color. In the medical sector, it would be practical when first a small sample of the substance could be tested to examine its effectiveness before a suitable device for treatment is bought, such as, a nasal-, throat- or pharynx spray or drops. It has also been seen in case of such medical products that the customers do not want to buy a substance, of whose effect on them they are not sure, since these treatment devices are relatively expensive and when they do not work, they become useless for the buyer.

For those, who offer medical sprays and drops, it would have been advantageous, on the other hand, to win customers, when they could offer a very small quantity of substance as sample, at first, where the substance could still be applied as spray or drops. Such dosing systems for medical, as well as for non-medical purposes, could then be offered for a modest price or even as free samples. It would have been easier for the customers to then test the substance or the spray content for their intended application and to buy the actual product, when they are convinced of its results. In this sense, too, such a dosing system could be a welcome marketing tool.

### SUMMARY OF THE INVENTION

It is, therefore, an object of the present invention to provide a dosing system, which makes it possible to apply small number of drops or doses of a spray and a process for the efficient manufacture of such a dosing system.

The foregoing and related objects are achieved by the dosing system of the present invention, which comprises an atomizer nozzle or a dropper on a shoulder and two external arms, which are linked with the same, and a round container in the shape of a hollow cylinder, lying in between them. The two external arms are joined with one another through inner arms, which are at acute angles with them, and through U-shaped tension arches, and are provided with means for pressing them together gradually and repeatedly.

The process for manufacturing the dosing system of the present invention comprises the steps of:

a) a shoulder with a sealed nozzle body on it is injection molded out of plastic, having two outer and inner arms on opposite sides, which are linked to the shoulder through integral hinges with these arms being connected with one another through a U-shaped tension arch respectively, and a cylinder, which is formed at the bottom side of the shoulder;

b) the cylinder is stuffed from below through its bottom opening; and,

c) the cylinder is fitted and thus closed at its bottom, open end with a plunger system, comprising plunger tail, plunger pin with a plunger head on it and plunger blades.

An alternative process for manufacturing the inventive dosing system, comprises the steps of:

a) a shoulder with a hole is injection molded out of plastic, having two outer and inner arms on opposite sides, which are linked to the shoulder through integral hinges and these arms being connected with one another through a U-shaped tension arch respectively, and a cylinder, which is formed at the bottom side of the shoulder;

b) the cylinder is fitted and thus closed at its bottom, open end with a plunger system, comprising plunger tail, plunger pin with a plunger head on it and two plunger blades;

c) the cylinder is stuffed through its hole from the outer side of the shoulder; and,

d) on the outer side of the shoulder, the hole in the shoulder is closed with a spray nozzle with a fork element put on it or a dropper.

Other objects and features of the present invention will become apparent when considered in combination with the accompanying drawing figures which illustrate certain preferred embodiments of the present invention. It should, however, be noted that the accompanying drawing figures are intended to illustrate only certain embodiments of the claimed invention and are not intended as a means for defining the limits and scope of the invention.

### BRIEF DESCRIPTION OF THE DRAWING FIGURES

The dosing system of the present invention is shown in different views in the drawing and its construction and function are explained hereinafter. The process of manufacture for the dosing system as per the invention is also described and explained as part of the detailed description of the structural features of the dosing system.

The accompanying drawing figures illustrate:

FIG. 1: The dosing system of the present invention with its plunger system and spray nozzle with fork element in a perspective view, as seen from side;

FIG. 2: The dosing system with its plunger system and spray nozzle with fork element, as in FIG. 1, but in a longitudinal section through its middle;

FIG. 3: The dosing system with its plunger system and spray nozzle with the fork element cut-off, in a perspective view, as seen from the side;

FIG. 4: The plunger system, comprising plunger tail with plunger blades and plunger pin and also the plunger head, schematically illustrated from the front;

FIG. 5: The plunger system, comprising plunger tail with plunger blades, as in FIG. 4, but with the plunger head put on, schematically illustrated from the front;

FIG. 6: The dosing system with its plunger system and spray nozzle with the fork element cut-off but put on upside down, in a perspective view, as seen from the side; and,

FIG. 7: A longitudinal cross section through the cylinder and a nozzle olive, which has been put on the cylinder mouth of the shoulder of the sample spray.

### DETAILED DESCRIPTION OF THE DRAWING FIGURES AND PREFERED EMBODIMENTS

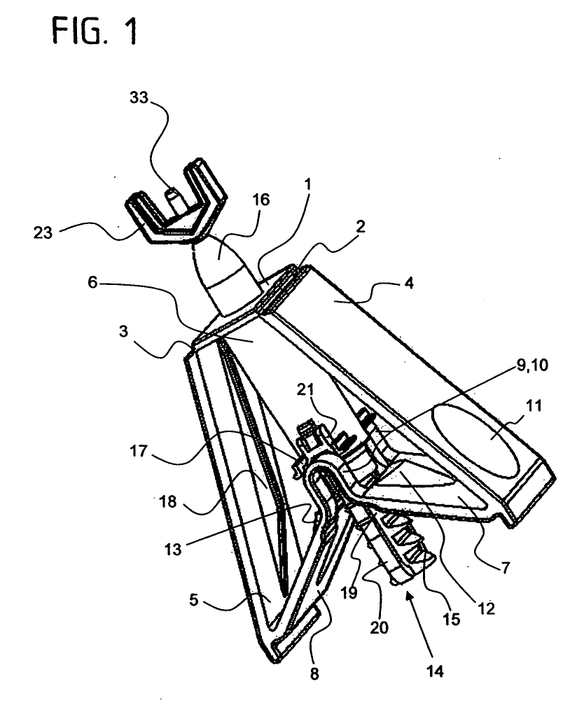

Turning now, in detail, to an analysis of the drawing figures, in FIG. 1, the dosing system of the present invention includes a plunger system 14 and spray nozzle 16 with fork element 23, shown in a perspective view, as seen from the side. The dosing system further comprises a shoulder 1, which has a hole in its center (not shown here) and two outer arms 4, 5 lying on opposite sides and being linked with the shoulder through integral hinges 2, 3 and a hollow cylinder 6, which is formed at the bottom side of the shoulder around the hole. Inner arms 7, 8 are formed at acute angle to the outer arms 4, 5, where these are connected with each other through two U-shaped tension arches 9, 10, so that the cylinder 6 is positioned centrally between the two tension arches 9, 10. The outer arms 4, 5 show oval-shaped dents 11 towards the lower end; said dents being of help in fixing the engaging fingers, namely the thumb and the index fingers, while pressing the outer arms 4, 5 with one hand and preventing the fingers from slipping off the arms. The inner arms 7, 8 have wedge type valves 12, 13 on the side, pointing towards the cylinder; their function will be explained in detail hereinafter. It would be sufficient to mention here that when the outer arms 4, 5 are pressed against each other, the wedge valves 12, 13 push the plunger system 14 with its latch keys 15 little-by-little into cylinder 6. The inner arms 7, 8, with the U-shaped tension arches 9, 10, then move upward in the direction of the nozzle body 16. This movement is guided, as well as restricted, by four L-shaped guide blocks 17, which are put on the cylinder wall, and by triangle-shaped arm blades 18, which are built at the inside of the outer arms 4, 5 centrally in their length direction, in so far as the movement can take place only up to the stopper of the wedge valves 12, 13 on the arm blades 18; wherein the extent of the movement, that is, the vertical stroke in the cylinder, is defined so that, for every pressing together of the outer arms 4, 5, the plunger system 14 moves forward gradually on the length of a latch key 15. The two plunger wings 20, lying at opposite side to each other on the plunger tail 19, are guided by two rails 21, which are formed on the cylinder wall, whereby the notches 22, which are at the outer sides of the plunger wings 20, move upward little-by-little around a latch element. The plunger system is thus fixed in its new position after the pressing together of the arms and the inner arms 7, 8 and the outer arms 4, 5 can relax after the finger pressure has been removed and they can go back to their initial position without the plunger system in the cylinder having to retract. Before the dosing system is used for the first time, and before the two arms 4, 5 are pressed together for the first time, the fork element 23 on nozzle body 16 must obviously be cut-off. In FIG. 1, the dosing system with the nozzle body 16, placed on, or molded on, the shoulder 1, and with the filled cylinder, is shown before the first use.

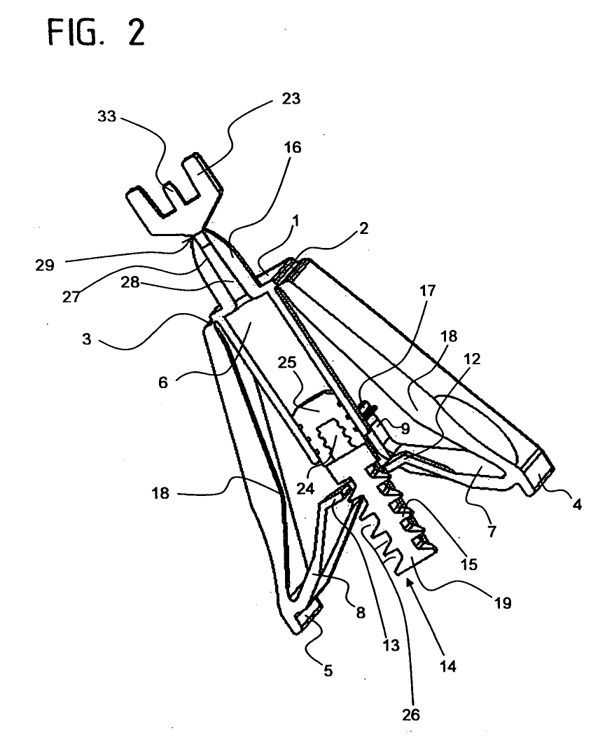

In FIG. 2, the dosing system with its plunger system 14 and nozzle body 16 with the fork element 23, which is put on, or molded integral, is shown as in FIG. 1, but in a longitudinal cross-section through the middle, with the cylinder filled before the first use. The plunger system comprises plunger tail 19, plunger pin 24 with external thread and plunger head 25, which is screwed-on or produced by a two-component injection molding process, where only the plunger head 25 is in the cylinder 6 at the initial position, i.e., before the first use, the plunger wings 20 being not visible in this illustration. Before the first use, the wedge valves 12, 13 of the inner arms 7, 8 are at the highest position of the plunger tail 19, i.e., in the two topmost grooves 26 of the plunger tail 19. In FIG. 2, the nozzle body 16, in the shape of an olive as a simple form is molded directly on shoulder 1 and made integral, so that nozzle hole 27 and nozzle channel 28 are identical and a fork element 23 is formed at the nozzle mouth 29. To make this dosing system ready for the first use, the fork element 23 must be removed through a rotation from the nozzle body 16, so that the nozzle mouth 29 becomes free and the olive shaped nozzle body can be put in the nostril.

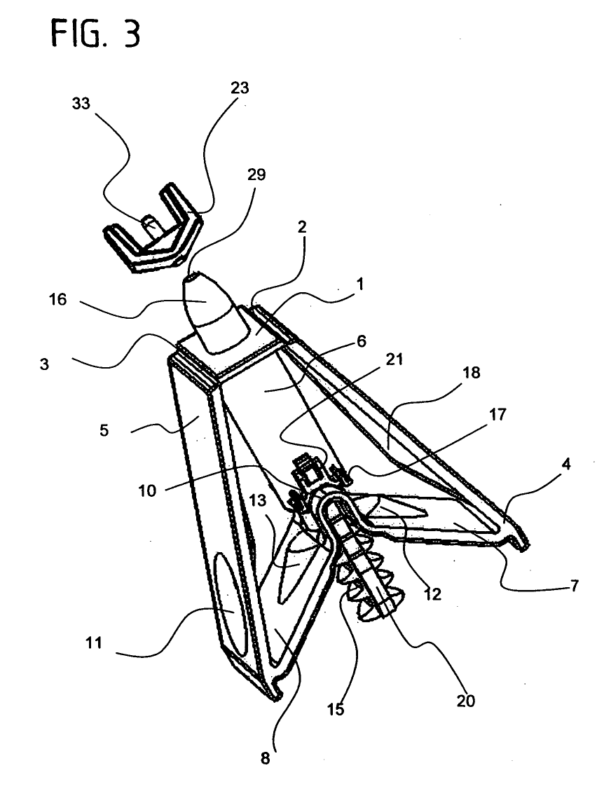

FIG. 3 shows the dosing system with its plunger system and spray nozzle with the fork element 23 cut-off in a perspective view, as seen from the side. When the fork element 23 is removed and the nozzle body 16 is put in the nostril, an elastic “pressing-together” of the outer arms 4, 5 takes place, whereby the wedge valves 12, 13 of plunger system 14 move upward and consequently an exact, definite volume of the liquid inside the cylinder is sprayed in the nose through the thin nozzle channel 28. The two wedge valves 12, 13 are pressed in the highest groove 26 when the outer arms 4, 5 are pressed together, by which the movement of the plunger system 14, in the direction of the nozzle body 16, is triggered. Further, the inner arms 7, 8 experience an upward movement, and the U-shaped tension arches 9, 10 similarly move upward, in the direction of the nozzle body 16 between the guide blocks 17. The extent of this movement is restricted by the arm blades 18, in that the outer arms 4, 5 can be pressed together up to the stopper of the arm blades 18 on the wedge valves 12, 13, and no farther. In this instance, the two plunger wings 20, which lie opposite to each other on the plunger tail 19, push themselves up approximately one latch element 22 through the two rails 21, which are fixed on the cylinder wall. The dosing system can relax after a definite volume of solution from the cylinder has been sprayed in the nose, which means that it can go back to its original form in the sense that the pressure of the hand or the fingers is removed from the outer arms 4, 5. The U-shaped tension arches 9, 10, which were under tension, press the inner arms 7, 8 back to their original start position, when the system is relaxed. Central to this process is, however, that the plunger system 14 does not relax, which means that it remains in that position which obtained after the first use in that, when the system is relaxed, the wedge valves 12, 13 slide downwardly from the highest groove 26 over the highest, “Christmas-tree” shaped latch key, so that the wedge valves 12, 13 can get hooked into the next highest groove of the plunger tail 19 for the next application of the solution. The plunger system 14 is held in its position, since the two plunger wings 20 cannot move down any further as these have been squeezed by the latch elements 22, which have been clicked in the rails 21. Through every contraction of the outer arms 4, 5, the inside volume of the cylinder is also reduced gradually and irreversibly, and an exact, defined amount of solution of virtually identical size is applied to the nose each time.

The dosing system can be used those many times as there are number of grooves 26 present in the plunger tail 19, whereby the plunger system 14 is inserted completely into the cylinder and the plunger head 25 touches the inside edge of shoulder 1 and the entire amount of solution is applied. By varying the length of the plunger head 25, the number of impact strokes can also be made smaller since for the same cylinder geometry and volume and for an extended plunger head 25, it knocks at shoulder 1 for a lesser number of contractions. Depending on the type of solution to be applied and the desired effect, the number of contractions to be carried out and the total volume of the liquid at one's disposal can be controlled by means of cylinder heads of different length, where all other parts of the dosing system remain unchanged in design and geometry.

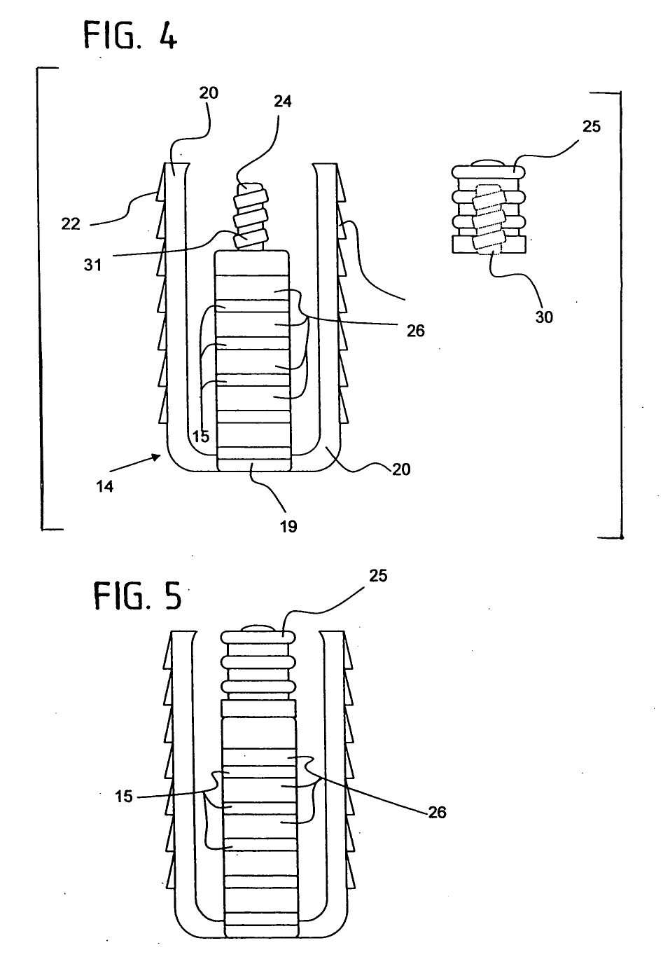

In FIG. 4, the plunger system 14, comprising plunger tail 19, with plunger wings 20, plunger pin 24 and plunger head 25 (not unscrewed), being shown schematically from the front. Latch elements 22, present on the outer sides of both the plunger wings 20, can be clearly seen in this view. When the plunger system 14 advances gradually in the cylinder through the two wing rails 21, which are fixed on the cylinder wall, these latch elements are pressed, whereby the latch elements 22 prevent, as barbed hook, a sliding downward of the plunger system 14, since these cannot move backwards by themselves through the wing rails 21. The circular plunger tail 19 is provided with grooves 26 and latch keys 15. Before the first use, the two wedge valves 12, 13 are in the highest groove of the plunger tail 19, and when the outer arms 4, 5 are pressed together, the wedge valves hook in the groove 26 and carry out an upward movement, so that the plunger system 14 is pressed upward. If the arms are now released, i.e., if the system relaxes, the arms 4, 5, 7, 8 swing back again, released through the U-shaped tension arches 9, 10 when, however, the plunger system 14 is prevented from going back through latch elements 22, which are hooked in the wing rails 21.

Before the plunger system is inserted in the cylinder, the plunger head 25, as long as it is not manufactured as a single component in a two-component injection molding process, has an internal thread 30 and is screwed on the plunger pin with an external thread. By varying the length of plunger head 25, the cylinder volume, which is kept at the disposal of the liquid, can be controlled. As per the requirement, for example, for very costly substances, it is thus possible, e.g., by using the appropriate plunger head 25, that the dosing system is limited to two applications.

In FIG. 5, as in FIG. 4, the plunger system 14 is shown schematically from the front, but with the plunger head put on. In case of sealed nozzle body 16, stuffing of the cylinder 6 takes place from below before the plunger system 14 is inserted—it is, however, also possible that the plunger system 14 is already inserted in the cylinder, so that the stuffing of the hollow cylinder takes place from top through the cylinder mouth 32, when the nozzle body 16 is subsequently put on.

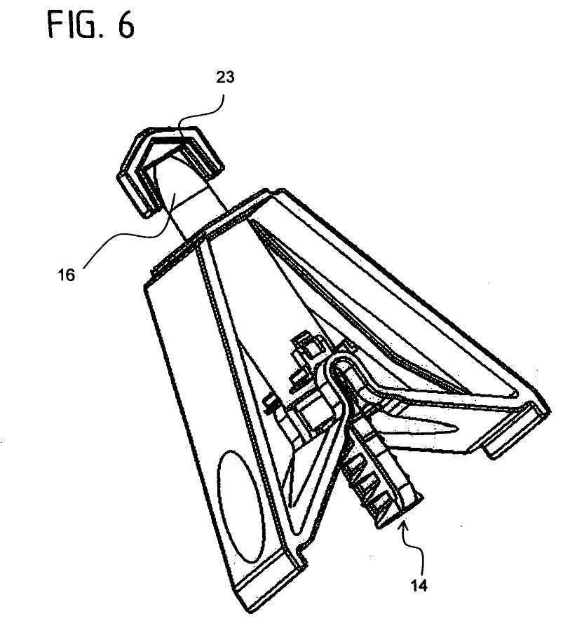

In FIG. 6, the dosing system with inserted plunger system 14 and spray nozzle 16 with fork element 23, which is cut-off, but again put on upside-down, is seen in the position of use in a perspective view, as seen from the side. After the fork element 23 has been cut off, the spigot 33 at the center of the fork element 23, can be put in the nozzle hole 34, so that the dosing system or the hollow cylinder with its liquid, contained therein, becomes hermetically air tight until the next application. For fresh use, the fork element 23 can be removed from the nozzle hole 34 by light rotation and can easily be closed again after the application.

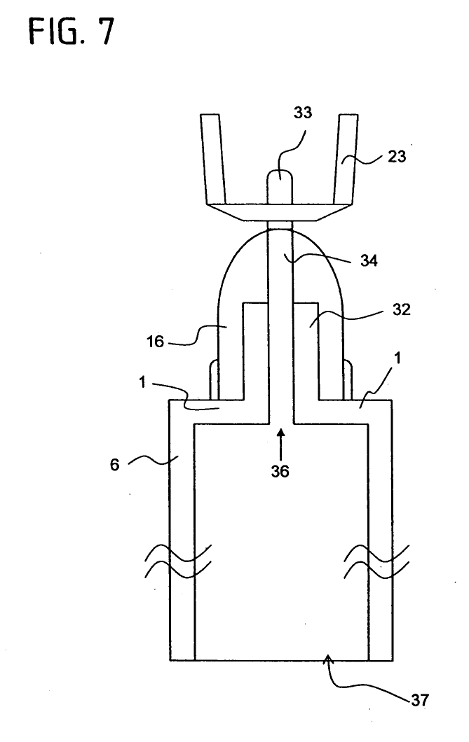

In FIG. 7, a longitudinal cross-section through the cylinder 6 and the nozzle olive 16 is shown as a variant with nozzle body, which can be put on. The shoulder 1 at the upper end of the cylinder 6 gets reduced to the cylinder mouth 32, on which the nozzle body 16 is placed on in the shape of a half olive; the nozzle hole 34 extends itself at the cylinder mouth 32 up to the nozzle mouth 29, where the liquid drops in an exact dose or is sprayed fine under pressure. A dropper- or spraying nozzle of such a shape is particularly suitable for nasal spray since the olive-shaped nozzle can be placed in a nostril. Prior to the first use, a molded fork element 23 is found at the nozzle mouth and it can be cut-off through a rotational movement. Alternatively, the nozzle hole 27 can be closed by a plug 35, wherein it is held in the nozzle hole only by ‘thin positioning’ and can be removed through rotating it away from the hole and tearing the “thin positioning.”

While only several embodiments of the present invention have been shown and described, it will be obvious to those skilled in the art that many modifications may be made to the present invention without departing from the spirit and scope thereof.

### LIST OF REFERENCE NUMERALS

1 shoulder
2, 3 integral hinge
4, 5 outer arm
6 cylinder
7, 8 inner arm with wedge-type valve
9, 10 U-shaped tension arches
11 oval dent
12, 13 wedge-type valve
14 plunger system
15 latch key
16 nozzle body
17 L-shaped guide block
18 triangular-shaped arm blade
19 plunger tail
20 plunger wing
21 wing rail
22 latch element on plunger wing 20
23 fork element
24 plunger pin with external thread
25 plunger head with internal thread
26 grooves
27 nozzle hole
28 nozzle channel
29 nozzle mouth
30 internal thread of plunger head 25
31 external thread of plunger pin
32 cylinder mouth
33 spigot on fork element 23
34 nozzle hole
35 plug
36 hole on shoulder 1
37 bottom opening of cylinder

What is claimed is:

1. A dosing apparatus, comprising:
a shoulder;
a nozzle for use as a dropper or sprayer on said shoulder;
two outer arms connected to said shoulder;
a container located between said two outer arms;
two inner arms each formed at an acute angle to an adjacent outer arm of said two outer arms with said two outer arms being connected to one another via said two inner arms;
two U-shaped tension arches connecting said two inner arms to one another, so that said container is centrally positioned between said two U-shaped tension arches; and,
means for pressing said two outer arms together gradually and repeatedly.

2. The dosing apparatus according to claim 1, wherein said container is a hollow cylinder.

3. The dosing apparatus according to claim 1, wherein said two outer arms are connected to said shoulder via hinges.

4. The dosing apparatus according to claim 1, wherein said shoulder has a hole therethrough with said container located on an inner side of said shoulder adjacent said hole through said shoulder and said nozzle located on an outer side of said shoulder adjacent said hole through said shoulder.

5. The dosing apparatus according to claim 1, further comprising a plunger device pushable through a bottom opening of said container and wherein said two inner arms further includes wedge valves, so that said plunger device is capable of being ratcheted, via said wedge valves, through the bottom opening of said container when said two outer arms are pressed together gradually and repeatedly.

6. The dosing apparatus according to claim 5, wherein said plunger device comprises:
plunger wings having latch elements on outer sides of said plunger wings;
a plunger tail with a latch key and grooves;
wing rails being located on opposite sides of an outer wall of said container through which said plunger wings with said latch elements are pushed and irreversibly hook via pressure of said latch key in said grooves when said two outer arms are pressed together;
guide blocks adjacent said wing rails on said outer wall of said container through which said U-shaped tension arches, movable in a direction of said nozzle when said two outer arms and said two inner arms, are pushed.

7. The dosing apparatus according to claim 5, wherein said plunger device comprises:
a plunger pin having external threading; and,
a plunger head having internal threading that is screwable onto said external threading of said plunger pin.

8. The dosing apparatus according to claim 1, wherein said means for pressing said two outer arms together gradually and repeatedly include dents on outer sides of each outer arm of said two outer arms for allowing a user to hand grip the outer sides of each said outer arm.

9. The dosing apparatus according to claim 1, wherein said means for pressing said two outer arms together gradually and repeatedly includes arm blades centrally located lengthwise along inner sides of said two outer arms with stops that are struck by said arm blades when said two outer arms are pressed together, thereby limiting pressing movement.

10. The dosing apparatus according to claim 9, wherein said stops are wedge valves.

11. The dosing apparatus according to claim 1, wherein said nozzle has a nozzle body shaped as a half olive.

12. The dosing apparatus according to claim 1, wherein said nozzle includes a fork element having a spigot which, after said fork element is removed, is placed on a nozzle carrier for closing a hole for said nozzle to allowing repeated use of said nozzle.

13. The dosing apparatus according to claim 1, wherein said nozzle includes a fork element having a spigot and a plug for closing a nozzle hole via “thin positioning” prior to an initial usage, which is removable via snapping of said “thin positioning,” so that said nozzle hole is openable and closable by said spigot for multiple uses.

14. A method for producing a dosing apparatus, said dosing apparatus comprising:
a shoulder;
a nozzle for use as a dropper or sprayer on said shoulder;
two outer arms connected to said shoulder;
a container located between said two outer arms;
two inner arms each formed at an acute angle to an adjacent outer arm of said two outer arms with said two outer arms being connected to one another via said two inner arms;
two U-shaped tension arches connecting said two inner arms to one another, so that said container is centrally positioned between said two U-shaped tension arches; and,
means for pressing said two outer arms together gradually and repeatedly,
said method for producing said dosing apparatus comprising the steps of:
injection molding said shoulder with said nozzle, said two outer arms and said two inner arms lying at opposite sides and connected to said shoulder via hinges;
connecting said two inner arms to one another via tension arches;
placing said container at a bottom side of said shoulder between said two outer arms;
opening said bottom side of said container for creating a bottom opening;
closing said bottom opening of said container with a plunger system pushable through said bottom opening of said container.

15. The method for producing a dosing apparatus according to claim 14, further comprising the step of;
providing said nozzle with a removable fork element.
